(19) United States
(12) Patent Application Publication
(10) Pub. No.: US 2013/0271617 A1
(43) Pub. Date: Oct. 17, 2013

(54) Optical Image Stabilization

(71) Applicants: Mikko Juhola, Muurla (FI); Mikko Antti Ollila, Tampere (FI); Mika Pitkanen, Akaa (FI)

(72) Inventors: Mikko Juhola, Muurla (FI); Mikko Antti Ollila, Tampere (FI); Mika Pitkanen, Akaa (FI)

(73) Assignee: Nokia Corporation, Espoo (FI)

(21) Appl. No.: 13/880,117

(22) PCT Filed: Oct. 20, 2010
(86) PCT No.: PCT/IB2010/054757

§ 371 Date: Jun. 12, 2013

(51) Int. Cl. G02B 27/64

(52) U.S. Cl. CPC G02B 27/64
USPC 348/208.11

(57) ABSTRACT

An apparatus including an image sensor; a lens for focusing an optical image onto the image sensor; a driver configured to move the lens at least in a first direction, wherein the lens includes a central region and first and second outer regions on either side of the central region in the first direction, wherein the first and second outer regions optically distort more than the central region.

### TECHNOLOGICAL FIELD

Embodiments of the present invention relate to optical image stabilization.

### BACKGROUND

An optical image stabilizer (OIS) is used in a still camera or video camera to stabilizes a recorded image. It varies the optical path to the image sensor, stabilizing the projected image on the image sensor before it is captured and recorded.

There are currently two solutions. One solution uses complex fixed or replaceable lens units that have in-built optical image stabilization and another solution moves the image sensor.

The complex replaceable lens units occupy a large volume and are complex. Moving the image sensor to compensate for camera movement can introduce a parallax error.

When a camera tilts towards/away from an object, the object image is compressed where the camera sensor moves away (greater field of view) and is expanded where the sensor moves towards (smaller field of view). The error caused in the image by expansion at one side and contraction at the other side is the parallax error.

The parallax error becomes more noticeable for cameras with larger fields of view such as ‘point and shoot’ cameras which are common in hand portable apparatus and the error becomes less noticeable for cameras with smaller fields of view such as telephoto lens cameras.

### BRIEF SUMMARY

When a camera tilts towards/away from an object, the object image is compressed where the camera sensor moves away (greater field of view) and is expanded where the sensor moves towards (smaller field of view). The error caused in the image by expansion at one side and contraction at the other side is the parallax error.

The parallax error may be resolved into an error formed by lateral movement and an error formed by a transverse pinch. Where the tilt is about a y-axis the compression may be resolved into a lateral movement in an x-direction and a transverse pinch in a y-direction.

The expansion error may be resolved into an error formed by lateral movement and an error formed by a transverse stretch. Where the tilt is about a y-axis the expansion may be resolved into a lateral movement in a x-direction and a transverse stretch in a y-direction.

A lateral shift of the sensor (e.g. in the x-direction) removes those parts of the errors formed by lateral movement, but does not resolve the pinch and stretch errors at opposite ends of the image.

However the movement of a lens that comprises a central region and first and second outer regions on either side of the central region in the first direction, where the first and second outer regions optically distort more than the central region, introduces a stretch distortion to compensate for the pinch error and a pinch distortion to compensate for the stretch error. That resolves or ameliorates the pinch error and the stretch error at opposite ends of the image.

According to various, but not necessarily all, embodiments of the invention there is provided an apparatus comprising: an image sensor; a lens for focusing an optical image onto the image sensor; a driver configured to move the lens at least in a first direction, wherein the lens comprises a central region and first and second outer regions on either side of the central region in the first direction, wherein the first and second outer regions optically distort more than the central region.

According to various, but not necessarily all, embodiments of the invention there is provided a method comprising: shifting an optical image focused on an image sensor towards a first region of the image sensor and away from a second region of the image sensor by moving a lens; expanding, orthogonally to the shift of the optical image, the optical image focused on the first region of the image sensor using a change in distortion provided by the lens as a consequence of the movement of the lens; and compressing, orthogonally to the shift of the optical image, the optical image focused on the second region of the image sensor using a change in distortion provided by the lens as a consequence of the movement of the lens

According to various, but not necessarily all, embodiments of the invention there is provided a method comprising shifting an optical image towards a first region of the optical image and away from a second region of the optical image; expanding, at least orthogonally to the shift, the first region of the optical image; and compressing, at least orthogonally to the shift, the second region of optical image.

### BRIEF DESCRIPTION

For a better understanding of various examples of embodiments of the present invention reference will now be made by way of example only to the accompanying drawings in which:

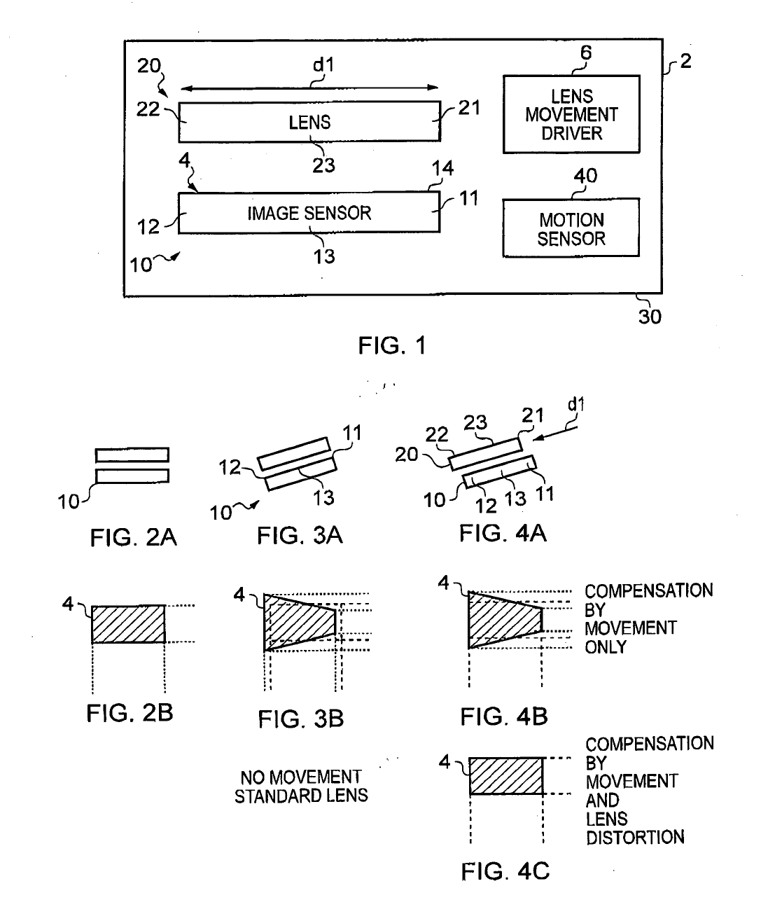

FIG. 1 schematically illustrates an apparatus comprising an image sensor, a lens 20 and a driver 6 for moving the lens;

FIG. 2A schematically illustrates the combination of a standard prior art lens and image sensor without yaw and FIG. 2B schematically illustrates the image 4 formed by the configuration of FIG. 2A;

FIG. 3A schematically illustrates the combination of a standard prior art lens and image sensor with yaw and FIG. 3B schematically illustrates the image 4 formed by the configuration of FIG. 3A;

FIG. 4A schematically illustrates the combination of a specifically designed lens and an with yaw, FIG. 4B illustrates the effect of a lateral shift on the image and

FIG. 4C illustrates the effect of a lateral shift of the specifically designed lens on the image;

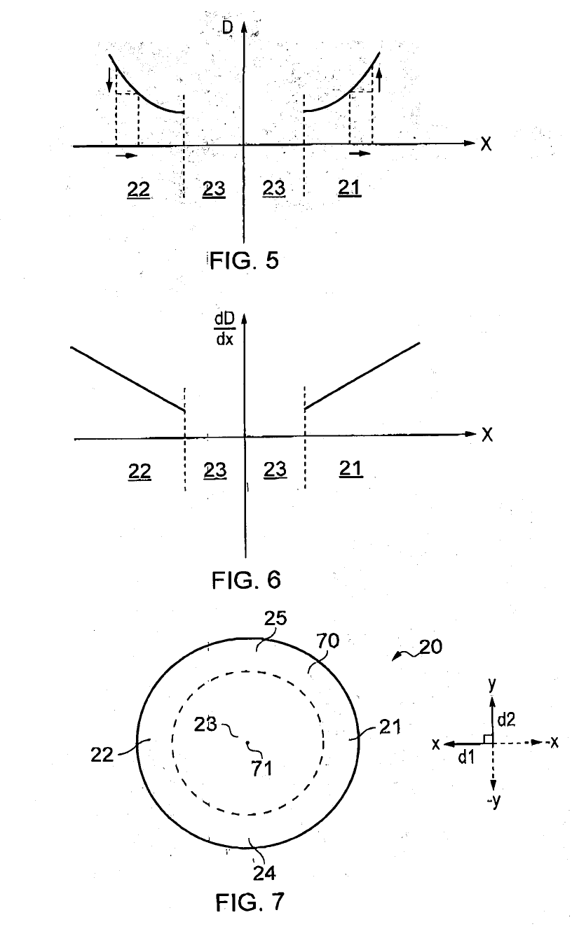

FIG. 5 schematically illustrates the distortion provided by an example of the specifically lens;

FIG. 6 schematically illustrates the differential of distortion provided by an example of the specifically lens;

FIG. 7 schematically illustrates an example of a specifically designed lens; and

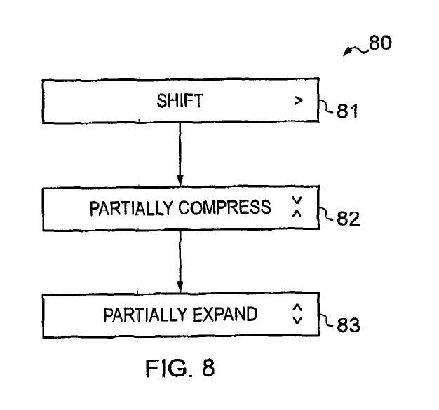

FIG. 8 schematically illustrates a method.

### DETAILED DESCRIPTION

FIG. 1 schematically illustrates an apparatus 2 comprising: an image sensor 10; an optical element (e.g. lens 20) for focusing an optical image 4 onto the image sensor 10; a driver 6 configured to move the optical element at least in a first direction d1, wherein the optical element comprises a central region 23, and a first outer region 21 and a second outer region 22 on either side of the central region 23 in the first direction d1, wherein the first and second outer regions optically distort more than the central region 23.

In this document where the term ‘lens’ is used it mean a lens (an optical element that focuses light) or a system comprising one or more lenses.

The image sensor 10 has an image plane 14 on which the image 4 is focused by the lens 20. The image sensor 10 may, for example, be a high quality image sensor having, for example, in excess of 6M pixels, 12M pixels or 18M pixels.

The lens 20 may have a wide field of view e.g. an angle of view greater than 30 degrees or greater than 60 degrees across both the horizontal and the vertical.

The lens 20 is mounted for movement substantially parallel to the image plane 14. It may, for example, be moved in the first direction d1 either in a positive sense (+x) or a negative sense (−x). It may, for example, also be moved in a second direction d2 (illustrated in FIG. 7), which is orthogonal to the first direction d1, either in a positive sense (+y) or a negative sense (−y.) In some embodiments the lens 20 may be moved simultaneously in both the first direction and the second direction.

A lens movement driver 6 is configured to move the lens 20. The driver 6 may, for example, use mechanical linkages to move the lens 20 or may, for example, use electromagnetism to control the position of the lens 20.

The apparatus 2 may also comprise one or more motion sensors 40 such as gyroscopes, accelerometers or other sensors that can detect a change in orientation.

If the motion sensor 40 detects a yaw about the y axis, then the lens driver 6 may move the lens in the first direction d1 either in the +x sense or the −x sense depending upon the direction of yaw about the y-axis.

If the optical sensor has a first region 11 associated with the first region 21 of the lens 20, a second region 12 associated with the second region 22 of the lens 20, and a central region 13 associated with the central region 23 of the lens 20, then if the yaw about the y axis causes the first region 11 of the sensor 11 to lead the second region 12 of the sensor, the lens 20 is moved in the first direction (parallel to the image sensor 10) in a sense from the leading first region 21 towards the lagging second region 22 (in the +x direction in FIG. 7).

If the yaw about the y axis causes the first region 11 of the sensor 11 to lag the second region 12 of the sensor, the lens 20 is moved in the first direction (parallel to the image plane 14) in a sense from the leading second region 22 towards the lagging first region 21 (in the +x direction in FIG. 7).

Referring to FIG. 7, the lens 20 may additionally comprise a third outer region 24 and a fourth outer region 25 on either side of the central region 23 in a second direction d2 that is orthogonal to the first direction but parallel to the image plane 14 of the image sensor 10. The third outer region 24 and the fourth outer region 25 optically distort more than the central region 23.

If the motion sensor 40 detects a pitch about the x axis, then the lens driver 6 may move the lens in the second direction d2 either in the +y sense or the −y sense depending upon the direction of pitch about the x-axis.

If the optical sensor has a third region associated with the third region 24 of the lens 20 and a fourth region associated with the fourth region 25 of the lens 20, then if the pitch about the x axis causes the third region of the sensor 10 to lead the fourth region of the sensor 10, the lens 20 is moved in the second direction (parallel to the image plane 14) in a sense from the leading third region 24 of the lens 20 towards the lagging fourth region 25 of the lens 20 (in the +y direction in FIG. 7).

If the pitch about the x axis causes the third region of the sensor 10 to lag the fourth region of the sensor 10, the lens 20 is moved in the second direction (parallel to the image plane 14) in a sense from the leading fourth region 25 of the lens 20 towards the lagging third region 24 of the lens 20 (in the −y direction in FIG. 7).

The apparatus 2 may have a housing 30 and the lens 20 may be moved relative to housing 30. The optical sensor 10 may be fixed relative to the housing 30.

The apparatus 2 may be a hand portable electronic apparatus or a mobile personal apparatus, such as, for example a mobile cellular telephone, a personal media recorder/player etc.

FIG. 2A schematically illustrates the combination of a standard prior art lens and image sensor 10 without yaw and FIG. 2B schematically illustrates the image 4 formed by the lens 20 and its relationship to the image sensor 10. The image plane 14 of the image sensor 10 is illustrated using dashed lines. The image 4 is illustrated using hatching. In this example, the image 4 and the image plane 14 are in aligned.

FIG. 3A schematically illustrates the combination of the standard prior art lens and the image sensor 10 with yaw about the y axis. The yaw causes the first region 11 of the sensor 10 to lead the second region 12 of the sensor 10. FIG. 2B schematically illustrates the image 4 formed by the configuration of FIG. 3A and its relationship to the image sensor 10. The image plane 14 of the image sensor 10 is illustrated using dashed lines. The image 4 is illustrated using hatching.

When the image sensor 10 tilts away, the image 4 is expanded (greater field of view) so that it extends beyond the edges of a lagging region of the image plane 14. When the image sensor 10 tilts towards, the image 4 is compressed (smaller field of view) so that it lies within a leading region of the image plane 14. The error caused in the image by expansion at the lagging side and contraction at the leading side is a parallax error.

The compression error at the leading edges may be resolved into an error formed by lateral movement and an error formed by a transverse pinch. Where the tilt is about a y-axis the compression may be resolved into a lateral movement in an x-direction and a transverse pinch in the y-direction.

The expansion error at the lagging edges may be resolved into an error formed by lateral movement and an error formed by a transverse stretch. Where the tilt is about a y-axis the expansion may be resolved into a lateral movement in a x-direction and a transverse stretch in a y-direction.

FIG. 4A schematically illustrates the combination of the lens 20 and the image sensor 10 with yaw about the y axis that causes the first region 11 of the sensor 11 to lead the second region 12 of the sensor. The configuration is similar to that illustrated in FIG. 3A except that the lens 20 is used instead of a standard prior art lens.

Referring to FIG. 4B, a lateral shift of the lens 20 by the driver 6 (e.g. in the +x-direction) removes those parts of the errors formed by lateral movement, but does not resolve the pinch and stretch errors at opposite ends 11, 12 of the image sensor 10.

However, referring to FIG. 4C, the use of the lens 20 and its movement in the x-direction introduces an expansion or stretch distortion in the +y and −y directions to compensate for the pinch error and a compression or pinch distortion in the +y and −y directions to compensate for the stretch error. A change in distortion provided by the second outer region 22 of the lens 20, as a consequence of the movement in the first direction d1 (away from but parallel to the sensor), compresses the optical image focused on the second region 12 of the image sensor 10.

A change in distortion provided by the first outer region 21, as a consequence of the movement in the first direction (towards but parallel to the sensor), expands the optical image 4 focused on the first region 11 of the image sensor 10.

The lens 20 may have negative distortion (image magnification decreases with distance away from the central region 23). The absolute value of the distortion increases (becomes more negative i.e. more compressive) in at least the second outer region 22 with distance away from the central region 23.

FIG. 5 schematically illustrates the distortion provided by the lens 20.

The lens 20 is configured to provide an absolute value of distortion D that increases monotonically with absolute distance x from central region 23 of the lens 20.

The absolute value of distortion D is symmetric about the axis x=0. Consequently, the first outer region and the second outer region, have symmetric distortion when measured from a center of the lens 20.

In this example, the absolute value of distortion D is a second order quadratic in the absolute distance x from the central region 23 of the lens 20.

Consequently, as illustrated in FIG. 6, the increase in distortion with absolute distance from central region of the lens (dD/dx) is linear in the absolute distance x from central region 23 of the lens 20.

Consequently, the change in distortion provided by the second outer region 22, as a consequence of the movement in the first direction x, is proportional to the movement and the change in distortion provided by the first outer region 21, as a consequence of that movement in the first direction x, is proportional to the movement. The change in distortion provided by the second outer region 22 and the change in distortion provided by the first outer region 21, as a consequence of the movement in the first direction, has the same absolute value but opposite sense.

Although FIGS. 5 and 6 illustrate how the absolute value of distortion and change in absolute value of distortion D change with the movement of the lens 20 in the first x direction, similar figures would illustrate how the absolute value of distortion and change in absolute value of distortion D change with the movement of the lens 20 in the second y direction orthogonal to the first x direction.

FIG. 7 schematically illustrates a lens 20 in which the first outer region 21 and the second outer region 22 are opposing portions of a peripheral edge 70 of the lens 20 that circumscribes the central region 23 and are separated in the first x direction and in which the third outer region 24 and the fourth outer region 25 are opposing portions of the peripheral edge 70 of the lens 20 that circumscribes the central region 23 and are separated in the second y-direction.

The peripheral edge region 70, which comprises the first and second outer regions and the third and fourth outer regions, optically distorts more than the central region 23 it circumscribes.

The peripheral region 70 may, for example provide barrel distortion. In barrel distortion, distortion is negative and image magnification decreases with distance from the optical axis 71. The absolute value of the distortion increases (becomes more negative i.e. more compressive) with distance from the optical axis. The effect is of an image mapped onto a barrel or sphere.

A change in distortion provided by the peripheral region 70, as a consequence of the movement of the lens in the first direction and/or second direction, compresses the optical image focused on the portion of the image sensor 10 towards which the lens 20 moves (in a plane parallel to the image sensor) and expands the optical image focused on the portion of the image sensor 10 away from which the lens 20 moves (in a plane parallel to the image sensor).

FIG. 8 schematically illustrates a method 80 comprising blocks 81, 82, 83.

At block 81, the method comprises shifting an optical image focused on an image sensor 10 towards a first region 11 of the image sensor and away from a second region 12 of the image sensor 10 by moving a lens 20.

At block 82, the method comprises expanding, orthogonally to the shift of the optical image 4, the optical image 4 focused on the first region 11 of the image sensor 10 using a change in distortion provided by the lens 20 as a consequence of the movement of the lens 20.

At block 83, the method comprises compressing, orthogonally to the shift of the optical image 4, the optical image 4 focused on the second region 12 of the image sensor 10 using a change in distortion provided by the lens 20 as a consequence of the movement of the lens 20.

The method 80 is performed in response to a yaw of the image sensor 10 in which the first region 11 of the image sensor 10 leads the second region 12 of the image sensor 10.

In response to a yaw of the image sensor in which the second region 12 of the image sensor 10 leads the first region 11 of the image sensor, the method 80 may comprise: shifting 81 an optical image focused on an image sensor towards the second region of the image sensor and away from the first region of the image sensor by moving the lens; compressing 82 orthogonally to the shift of the optical image, the optical image focused on the first region of the image sensor using a change in distortion provided by the lens as a consequence of the movement of the lens; and expanding 83, orthogonally to the shift of the optical image, the optical image focused on the second region of the image sensor using a change in distortion provided by the lens as a consequence of the movement of the lens

In response to a pitch of the image sensor in which a third region of the image sensor leads a fourth region of the image sensor, the method 80 may comprise: shifting 81 an optical image focused on an image sensor towards the third region of the image sensor and away from the fourth region of the image sensor by moving the lens; compressing 82, orthogonally to the shift of the optical image, the optical image focused on the fourth region of the image sensor using a change in distortion provided by the lens as a consequence of the movement of the lens; and expanding 83, orthogonally to the shift of the optical image, the optical image focused on the third region of the image sensor using a change in distortion provided by the lens as a consequence of the movement of the lens;

In response to a pitch of the image sensor in which a third region of the image sensor lags the fourth region of the image sensor, the method 80 comprises: shifting 81 an optical image focused on an image sensor towards the fourth region of the image sensor and away from the third region of the image sensor by moving the lens; compressing 82, orthogonally to the shift of the optical image, the optical image focused on the third region of the image sensor using a change in distortion provided by the lens as a consequence of the movement of the lens; and expanding 83, orthogonally to the shift of the optical image, the optical image focused on the fourth region of the image sensor using a change in distortion provided by the lens as a consequence of the movement of the lens.

A suitable lens 20 may be designed and manufactured, for example, as described below:

Initially, the maximum correction (tilt) angles αₓ, α_{y} for image stabilization are defined. αₓ is the maximum yaw angle about the y-axis. αₓ is the maximum pitch angle about x-axis. Typically these angles will be in the range 0.3-0.6 degrees.

The error in the x direction is given by:

Δx=f·(tan(βₓ/2+αₓ)−W/2

The lens should therefore be moved −Δx to correct this error.

βₓ is the angular field of view in the x-direction, f is the focal length of the lens and W is the width of the image in the x-direction.

The error in the y direction at the pinched edge is given by:

e1=f·(tan β_{y}−tan(βy−α_{y}))

The error in the y direction at the stretched edge is given by:

e2=f·(tan(β_{y}+α_{y})−tan β_{y})

where β_{y} is the angular field of view in the y-direction and f is the focal length of the lens.

The distortion of the lens is designed so that the change in distortion caused by Δx at x=−W/2 compensates for the error e1 and the change in distortion caused by Δx at x=W/2 compensates for the error e2.

If the distortion is modeled as a quadratic, D=kx² then solving along the x axis

Dₘₐₓ=k(W/2)²

and

Dₘₐₓ−e1=k(W/2−Δx)²

However, maximum distortion will occur along the diagonal, so solving for a 3×4 sensor geometry along the diagonal provides:

Dₘₐₓ=k(5/4)²(W/2)²

and

Dₘₐₓ−5/4*e1=k(5/4)²(W/2−Δx)²

Solving the equations gives k.

The blocks illustrated in FIG. 8 may represent steps in a method and/or sections of code in the computer program. The illustration of a particular order to the blocks does not necessarily imply that there is a required or preferred order for the blocks and the order and arrangement of the block may be varied. Furthermore, it may be possible for some blocks to be omitted.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/We claim:

1. An apparatus comprising:
an image sensor;
a lens for focusing an optical image onto the image sensor;
a driver configured to move the lens at least in a first direction,
wherein the lens comprises a central region and first and second outer regions on either side of the central region in the first direction, wherein the first and second outer regions optically distort more than the central region.

2. An apparatus as claimed in claim 1, wherein the first outer region and the second outer region provide negative distortion with absolute distance from central region of the lens.

3. An apparatus as claimed in claim 2 wherein the lens is configured to provide an absolute value of distortion, in at least the first and second outer regions, that increases with absolute distance from central region of the lens.

4. An apparatus as claimed in claim 1, wherein the lens is configured to provide an absolute value of distortion, in at least the first and second outer regions, that monotonically increases with absolute distance from central region of the lens.

5. An apparatus as claimed in claim 1, wherein the lens is configured to provide an absolute value of distortion that is second order wherein an increase in distortion with absolute distance from central region of the lens is linear in the absolute distance from central region of the lens.

6. An apparatus as claimed in claim 1, wherein the first outer region and the second outer region have symmetric distortion when measured from a center of the lens.

7. An apparatus as claimed in claim 1, wherein the first outer region and the second outer region are portions of a peripheral edge of the lens that circumscribes the central region.

8. An apparatus as claimed in claim 1, wherein a change in distortion provided by the second outer region, as a consequence of the movement of the lens in the first direction, compresses the optical image focused on the image sensor and a change in distortion provided by the first outer region, as a consequence of the movement of the lens in the first direction, expands the optical image focused on the image sensor.

9. An apparatus as claimed in claim 1, wherein the change in distortion provided by the second outer region, as a consequence of the movement in the first direction, is proportional to the movement and the change in distortion provided by the first outer region, as a consequence of the movement in the first direction, is proportional to the movement.

10. An apparatus as claimed in claim 1, wherein the change in distortion provided by the second outer region and the change in distortion provided by the first outer region, as a consequence of the movement in the first direction, has the same absolute value but opposite sense.

11. An apparatus as claimed in claim 1, further comprising a motion sensor configured to detect yaw in which one of the first or second outer regions leads the other of the first and second outer regions and wherein the driver is configured to move the lens in the first direction, when the motion sensor detects yaw in which the first outer region leads second outer region and the driver is configured to move the lens in an opposite sense to the first direction, when the motion sensor detects yaw in which the second outer region leads the first outer region.

12. An apparatus as claimed in claim 1, further comprising a driver configured to move the lens at least in a second direction orthogonal to first direction, wherein the lens comprises third and fourth outer regions on either side of the central region in the second direction, wherein the third and fourth outer regions optically distort more than the central region.

13. An apparatus as claimed in claim 12, wherein the third outer region and the fourth outer region have symmetric distortion when measured from a center of the lens.

14. An apparatus as claimed in claim 12, wherein the third outer region and the fourth outer region are portions of a peripheral edge of the lens that circumscribes the central region.

15. An apparatus as claimed in claim 12, wherein the third outer region and the fourth outer region have barrel distortion.

16. An apparatus as claimed in claim 12, wherein a change in distortion provided by the fourth outer region, as a consequence of the movement of the lens in the second direction, compresses the optical image focused on the image sensor and a change in distortion provided by the third outer region, as a consequence of the movement of the lens in the second direction, expands the optical image focused on the image sensor.

17. An apparatus as claimed in claim 12, wherein the change in distortion provided by the fourth outer region, as a consequence of the movement in the second direction, is proportional to the movement and the change in distortion provided by the third outer region, as a consequence of the movement in the second direction, is proportional to the movement.

18. An apparatus as claimed in claim 12, wherein the change in distortion provided by the fourth outer region and the change in distortion provided by the third outer region, as a consequence of the movement in the second direction, has the same absolute value but opposite sense.

19. An apparatus as claimed in claim 12, further comprising a motion sensor configured to detect pitch in which one of the third or fourth outer regions leads the other of the third and fourth outer regions and wherein the driver is configured to move the lens in the second direction, when the motion sensor detects yaw in which the third outer region leads the fourth outer region and the driver is configured to move the lens in an opposite sense to the second direction, when the motion sensor detects yaw in which the fourth outer region leads the third outer region.

20. An apparatus as claimed in claim 1 comprising a housing wherein the lens is mounted for movement relative to the housing and the optical sensor is fixed relative to the housing.

21. An apparatus as claimed in claim 1 configured as a hand-portable electronic apparatus or a mobile personal apparatus.

22. A method comprising
shifting an optical image focused on an image sensor towards a first region of the image sensor and away from a second region of the image sensor by moving a lens;
expanding, orthogonally to the shift of the optical image, the optical image focused on the first region of the image sensor using a change in distortion provided by the lens as a consequence of the movement of the lens; and compressing, orthogonally to the shift of the optical image, the optical image focused on the second region of the image sensor using a change in distortion provided by the lens as a consequence of the movement of the lens

23. A method comprising performing the method of claim 22 in response to a yaw of the image sensor in which the first of the image sensor leads the second region of the image sensor.

24. A method as claimed in claim 22, comprising, in response to a yaw of the image sensor in which the second region of the image sensor leads the first region of the image sensor:
shifting an optical image focused on an image sensor towards the second region of the image sensor and away from the first region of the image sensor by moving the lens;
compressing, orthogonally to the shift of the optical image, the optical image focused on the first region of the image sensor using a change in distortion provided by the lens as a consequence of the movement of the lens; and expanding, orthogonally to the shift of the optical image, the optical image focused on the second region of the image sensor using a change in distortion provided by the lens as a consequence of the movement of the lens

25. A method as claimed in claim 22, comprising, in response to a pitch of the image sensor in which a third region of the image sensor leads a fourth region of the image sensor:
shifting an optical image focused on an image sensor towards the third region of the image sensor and away from the fourth region of the image sensor by moving the lens;
expanding, orthogonally to the shift of the optical image, the optical image focused on the third region of the image sensor using a change in distortion provided by the lens as a consequence of the movement of the lens; and compressing, orthogonally to the shift of the optical image, the optical image focused on the fourth region of the image sensor using a change in distortion provided by the lens as a consequence of the movement of the lens.

26. A method as claimed in claim 25, comprising, in response to a pitch of the image sensor in which a third region of the image sensor lags the fourth region of the image sensor:
shifting an optical image focused on an image sensor towards the fourth region of the image sensor and away from the third region of the image sensor by moving the lens;
compressing, orthogonally to the shift of the optical image, the optical image focused on the third region of the image sensor using a change in distortion provided by the lens as a consequence of the movement of the lens; and expanding, orthogonally to the shift of the optical image, the optical image focused on the fourth region of the image sensor using a change in distortion provided by the lens as a consequence of the movement of the lens.

27. A method comprising
shifting an optical image towards a first region of the optical image and away from a second region of the optical image;
expanding, at least orthogonally to the shift, the first region of the optical image; and
compressing, at least orthogonally to the shift, the second region of optical image.
